(19) United States
(12) Patent Application Publication
(10) Pub. No.: US 2026/0161624 A1
(43) Pub. Date: Jun. 11, 2026

(54) MULTI-LEVEL DISTRIBUTED AI ASSISTANT

(71) Applicant: Synaptics Incorporated, San Jose, CA (US)

(72) Inventors: Dominic Pajak, San Jose, CA (US); Karthikeyan Shanmuga Vadivel, San Jose, CA (US)

(73) Assignee: Synaptics Incorporated, San Jose, CA (US)

(21) Appl. No.: 19/397,090

(22) Filed: Nov. 21, 2025

Related U.S. Application Data
(60) Provisional application No. 63/730,885, filed on Dec. 11, 2024.

(51) Int. Cl. G06F 16/22; G10L 13/02; G10L 15/08; G10L 15/183; G10L 15/22; G10L 15/26

(52) U.S. Cl. CPC G06F 16/2237; G10L 15/183; G10L 15/22; G10L 13/02; G10L 2015/088; G10L 15/26

(57) ABSTRACT

A method and a system for operating an artificial intelligence (AI) assistant. In some implementations, a method may include receiving a user input, the user input including a user question; generating a first vector representing the user question; matching the first vector to a second vector representing a question stored in a database of questions and answers at the computing device, the database of questions and answers including a plurality of questions extracted from a knowledge base associated with the computing device and respective answers associated with the plurality of questions; and selectively escalating the user question for processing by a machine learning model.

### CROSS-REFERENCE TO RELATED APPLICATIONS

This application claims the benefit of U.S. Provisional Application No. 63/730,885, titled “Multi-Level Distributed AI Assistant” and filed on Dec. 11, 2024, which is incorporated by reference herein in its entirety.

### TECHNICAL FIELD

This disclosure relates generally to the field of voice assistant applications, specifically to voice assistant applications utilizing artificial intelligence (AI).

### BACKGROUND OF RELATED ART

In implementations of voice-based assistants, artificial intelligence (AI) models often have a tradeoff between latency and accuracy. On-device solutions may enable low-latency responses, but limited processing power and memory on the device may limit the accuracy of those responses. Cloud-based solutions allow greater processing power and memory capabilities, but may increase latency significantly.

Many applications have a need for a focused set of responses. As one of various examples, a consumer appliance may implement a knowledge database to answer user questions and assist in troubleshooting. The complexity of a full cloud-based solution to an AI model, such as a general large language model (LLM), may not be feasible.

There exists a need for an AI assistant architecture that balances the tradeoff between latency and processing accuracy by enabling fast, on-device inference for routine queries and selectively escalating to more capable models only when necessary. Such an approach can improve responsiveness, reduce cloud dependency, and enhance user privacy.

### SUMMARY

This Summary is provided to introduce in a simplified form a selection of concepts that are further described below in the Detailed Description. This Summary is not intended to identify key features or essential features of the claims subject matter, nor is it intended to limit the scope of the claimed subject matter.

A method and a computing device are disclosed. One innovative aspect of the subject matter of this disclosure can be implemented in a method for operating an artificial intelligence assistant, the method comprising receiving a user input, the user input including a user question; generating a first vector representing the user question; matching the first vector to a second vector representing a question stored in a database of questions and answers at the computing device, the database of questions and answers including a plurality of questions extracted from a knowledge base associated with the computing device and respective answers associated with the plurality of questions; and selectively escalating the user question for processing by a machine learning model.

Another innovative aspect of the subject matter of this disclosure can be implemented in a computing device comprising a processing system and a memory. The memory stores instructions that, when executed by the processing system, causes the computing device to receive a user input, the user input including a user question; generate a first vector representing the user question; match the first vector to a second vector representing a question stored in a database of questions and answers at the computing device, the database of questions and answers including a plurality of questions extracted from a knowledge base associated with the computing device and respective answers associated with the plurality of questions; and selectively escalate the user question for processing by a machine learning model.

### BRIEF DESCRIPTION OF THE DRAWINGS

The present implementations are illustrated by way of example and are not intended to be limited by the figures of the accompanying drawings.

FIG. 1 illustrates an assistant system within which aspects of the present disclosure may be implemented.

FIG. 2 illustrates a block diagram of an example assistant engine, according to some implementations.

FIG. 3 illustrates an example of an operational flow for a first line query for an artificial intelligence (AI) assistant, according to some implementations.

FIG. 4 illustrates an example of an operational flow for a second line query for an AI assistant, according to some implementations.

FIG. 5 illustrates an example of an operational flow for a third line query for an AI assistant, according to some implementations.

FIG. 6 illustrates a block diagram of an assistant system, according to some implementations

FIG. 7 illustrates a flowchart depicting an example method of operating an AI assistant, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. The interconnection between circuit elements or software blocks may be shown as buses or as single signal lines. Each of the buses may alternatively be a single signal line, and each of the single signal lines may alternatively be buses, and a single line or bus may represent any one or more of a myriad of physical or logical mechanisms for communication between components.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory computer-readable storage medium comprising instructions that, when executed, performs one or more of the methods described above. The non-transitory computer-readable storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically-erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the implementations disclosed herein may be executed by one or more processors. The term “processor,” as used herein may refer to any general-purpose processor, conventional processor, controller, microcontroller, and/or state machine capable of executing scripts or instructions of one or more software programs stored in memory.

A device may implement an assistant application to help users with various tasks. For example, a consumer appliance may implement an assistant application to assist users with, for example, questions regarding operation of the appliance and/or troubleshooting the appliance. Often, an assistant application may implement artificial intelligence (AI) models.

An AI model may offer a tradeoff between latency and accuracy. An on-device AI model may be able to provide responses with lower latency. However, limitations on computing resources at the device (e.g., processing power, memory) may limit the accuracy of those responses. On the other hand, an AI model implemented in a cloud-based system may be able to provide more accurate responses due to the greater amount of computing resources available, but those responses may be provided at a higher latency than on-device.

By considering the natural conversational flow with the user, an approach which allows for escalation of AI inference to more capable (e.g., more computing resources at disposal) models as appropriate is described. An aim of this approach is to provide a fluid user interaction method lightweight enough to reside primarily on-device without reliance on cloud infrastructure for first or second line queries. In so doing, the approach enables the majority of responses to be provided on-device at low-latency, and provide a natural path to query more capable on-device models via second line methods. If appropriate, the system may connect to even more capable AI models on the network (locally, or on the cloud).

Accordingly, aspects of the present disclosure relate to operating an AI assistant. A computing device may receive a user input. The user input including a user question. The computing device may generate a first vector representing the user question and match the first vector to a second vector representing a question stored in a database of questions and answers at the computing device. The database of questions and answers includes a plurality of questions extracted from a knowledge base associated with the computing device and respective answers associated with the plurality of questions. The computing device may selectively escalate the user question for processing by a machine learning model.

Particular implementations of the subject matter described in this disclosure can be implemented to realize one or more of the following potential advantages. By using an on-device database of questions and answers in the first line, and escalating to more capable models in the second or third lines when necessary, an AI assistant may provide low-latency responses to user inputs more of the time, and use more capable models (with the tradeoff of higher latency) when necessary. This allows an AI assistant to provide responses at lower latency for the majority of user inputs and to escalate to more capable, but more resource-intensive and/or higher latency, processing for the user inputs that need such processing. This novel approach improves on the state of the art which either offers limited responses at low-latency, or high-latency communication with cloud-based services directly.

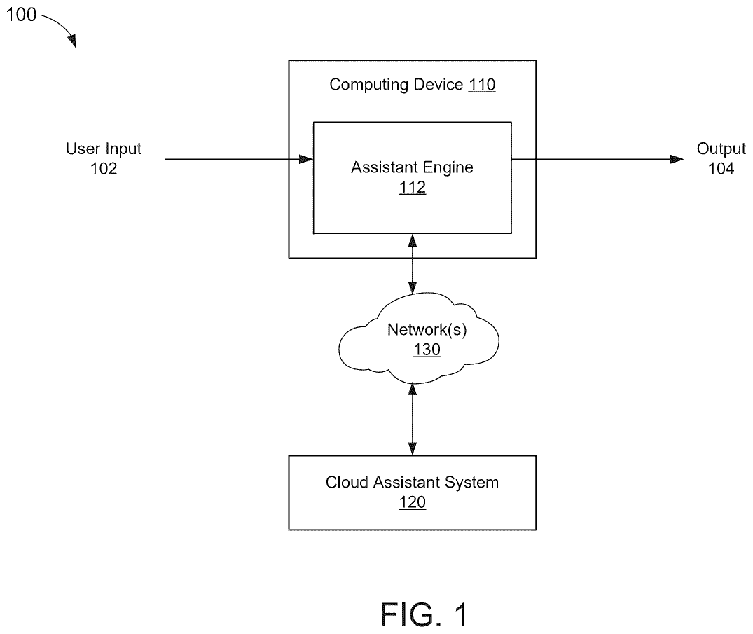

FIG. 1 illustrates an assistant system 100 within which aspects of the present disclosure may be implemented. Assistant system 100 includes a computing device 110, one or more networks 130, and a cloud assistant system 120.

The computing device 110 is a device that is configured to implement an assistant engine 112. The computing device 110 may be a device that includes a processing system, a memory, one or more input devices, one or more output devices, and a networking interface. The computing device 110 may implement the assistant engine 112 in conjunction with one or more of these components to provide an AI assistant capability at the computing device 110. In some implementations, the computing device 110 may be a desktop computer, a laptop computer, a cellular phone, a smartphone, a media device (e.g. a smart speaker), a game console, a media device, a consumer or household appliance (e.g., a washing machine, a drying machine, a stove, an oven, a refrigerator, a freezer, etc.), or any other device that includes a processing system, a memory, one or more input devices, one or more output devices, and a networking interface.

The computing device 110 may include (e.g., integrated into the device or communicatively coupled) one or more input devices, such as a keyboard, mouse, trackpad, touchscreen, touchpad, imaging sensor (e.g., camera), or microphone. The computing device 110 may include (e.g., integrated into the device or communicatively coupled) one or more output devices, such as a display device, or an audio output device (e.g., a speaker). In some implementations, the computing device 110 includes a microphone configured to receive audio input and an audio output device configured to output audio outputs.

The computing device 110 may include a networking interface configured to interface with one or more networks 130 and, via the networks 130, one or more remote systems, such as a cloud assistant system 120. The networks 130 may include, but is not limited to, local area networks, wide area networks, ad-hoc networks, cellular networks, and the Internet.

The assistant engine 112 is configured to provide AI assistant capability on the computing device 110. The AI assistant capability may include, for example, responding to questions or requests from a user with answers and/or performance of operations at the computing device 110. In some implementations, the assistant engine 112 may receive a user input 102, generate an output 104 responsive to the user input 102 using AI, and output the output 104. In some implementations, the assistant engine 112 may include software components (e.g., machine learning algorithms and programs) and/or hardware components (e.g., one or more processing units, memory, storage, etc.) configured to implement the AI assistant capability, and background data used for that capability (e.g., a knowledge data set, data for a machine learning model, etc.). In some implementations, the assistant engine 112 implements, at the computing device 110, one or more models associated with the AI assistant capability, including but not limited to a large language model (LLM) or a neural network model. For example, the assistant engine 112 may process a user input 102 to generate an output 104 based on the LLM.

In some implementations, the assistant engine 112 may receive a user input 102 via an input device (not shown) on the computing device 110. The user input 102 may be, for example, speech spoken by a user or a text input keyed in by the user. The user input 102 may include a question or request being asked by the user. The assistant engine 112 may process the user input 102 to generate an embedding vector representing the question or request. Depending on the modality of the user input 102 (e.g., text or speech), the processing may include performing speech to text processing on the user input 102. The assistant engine 112 may determine a response (e.g., a textual answer to the question) and may output the response as an output 104 in the same or different modality as the user input 102. For example, assistant engine 112 may output the textual answer as text displayed on a display device or speech converted from the textual answer and output via a speaker.

The cloud assistant system 120 is configured to provide cloud-based AI assistant capability to the computing device 110. The cloud-based AI assistant capability may include, for example, responding to questions or requests from a user, received from a device (e.g., computing device 110) remote from the cloud assistant system 120, with answers. In some implementations, the cloud-based assistant system 120 may receive a user question sent from a remote device (e.g., computing device 110), generate an output responsive to the question using AI, and send the output back to the remote device for output to the user. In some implementations, the cloud assistant system 120 may include software components (e.g., machine learning algorithms and programs) and/or hardware components (e.g., one or more servers, a distributed or cloud computing system) configured to implement the cloud-based assistant capability, and background data used for that capability (e.g., a knowledge data set, data for a machine learning model, etc.). In some implementations, the cloud assistant system 120 implements one or more models associated with its cloud-based AI assistant capability, including but not limited to a large language model (LLM) or a neural network model. In some implementations, the LLM implemented by the cloud assistant system 120 may be a larger scale version of the LLM implemented by the assistant engine 112 at the computing device 110.

In some implementations, a user may input a question to the assistant engine 112 in any of a number of modalities. For example, the user may type in a question as text or speak out the question as speech. The assistant engine 112 may receive the question as the user input 102. Depending on the modality of the user input 102, the assistant engine 112 may pre-process the user input 102 to obtain a text of the question. For example, if the user input 102 is speech, the assistant engine 102 may perform speech to text to convert the user input 102 to text. If the user input 102 is already in text form (e.g., the user typed in the user input 102), the assistant engine 102 may omit the pre-processing. In some implementations, the assistant engine 112 may then process the text corresponding to the user input 102 to transform the text into an embedding vector. An embedding vector may be a high-dimensional vector embodying the meaning of the text. Thus, an embedding vector for the user question may embody the meaning of the text of the question. By transforming the text of the question to an embedding vector, the assistant engine 112 may be able to identify matches to the user question based on similarity with respect to meaning (e.g., as measured by vector similarity) in addition or alternatively to keyword matching.

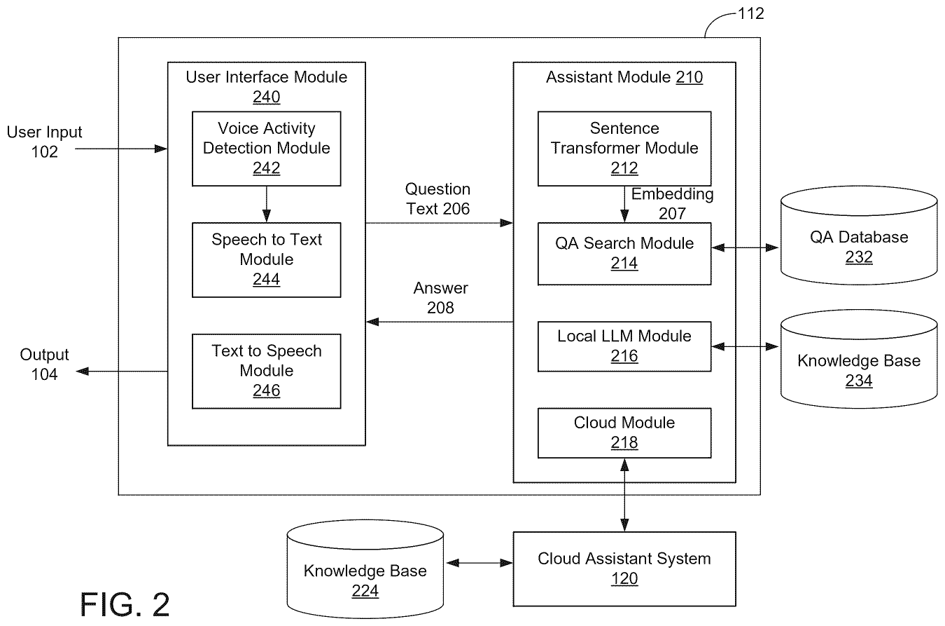

In some implementations, the assistant engine 112 may attempt to determine a response to the user question in multiple lines or levels of query, which may correspond to levels of escalation for the question. In a first line or first level query, the assistant engine 112 may determine a response to the user question by searching a database of questions and answers (e.g., QA database 232 of FIG. 2) to identify a question in the database that best matches the embedding vector of the input question. In some implementations, the assistant engine 112 may perform a semantic search using the embedding vector of the user question to identify a best matching question in the database. In some implementations, questions may be stored in the database of questions and answers as embedding vectors or text that may be transformed to embedding vectors. The assistant engine 112 may identify a question in the database of questions and answers that best matches the user question based on vector similarity (e.g., cosine similarity) between the embedding vector of the user question and the embedding vector of the question in the database of questions and answers. Responsive to identifying the best matching question, the assistant engine 112 may retrieve the answer corresponding to that best matching question from the database and output that answer as the output 104 in the same or different modality as the user input 102. For example, if the user spoke the user input 102 as speech, the assistant engine 112 may output the output 104 as speech as well.

In some implementations, the assistant engine 112 may receive a user input indicating whether the user is satisfied with the output answer output by the assistant engine 112. For example, the assistant engine 112 may prompt the user to indicate whether the user found the output answer helpful or not. If the user is satisfied with the output answer, the assistant engine 112 may end the first line query and return to standby awaiting a subsequent user question. If the user is not satisfied with the output answer, or if the assistant engine 112 fails to output an answer (e.g., the assistant engine 112 failed to identify a best matching question in the questions and answers database, the assistant engine 112 failed to identify a question in the question and answers database whose vector similarity to the user question is above a predetermined threshold), the assistant engine 112 may escalate the question to a second line or second level query.

In some implementations, the questions and answers database may be generated based on a knowledge base (e.g., knowledge base 224 or 234 of FIG. 2) associated with the computing device 110, which includes one or more documents associated with computing device 110. The questions and answers database may include specific questions and corresponding answers generated from the contents of the documents. The documents may include user and/or support documentation for the computing device 110, including but not limited to user manuals, technical support articles, troubleshooting guides, technical specifications, quick start guides, and/or the like. The computing device 110 (e.g., the assistant engine 112) or a remote system (e.g., the cloud assistant system 120) may analyze the one or more documents using machine learning techniques to determine one or more specific questions and corresponding answers from the document contents. In some implementations, the computing device 110 or the remote system may analyze the documents using a large language model (LLM), in order to extract a set of questions and corresponding answers from the documents for inclusion in the question and answers database. If performed by the remote device, the remote system may transmit the questions and answers database to the assistant engine 112 for storage at the computing device 110.

For example, for an assistant engine 112 implemented in a household appliance as the computing device 110, the cloud assistant system 120 may generate the questions and answers database from documentation (e.g., user manual, quick start guide, technical specifications, etc.) of the appliance. The cloud assistant system 120 may analyze the documentation using an LLM to extract one or more specific questions and corresponding answers for adding to the questions and answers database. The cloud assistant system 120 may transmit the questions and answers database to the assistant engine 112 for storage at the computing device 110. As the documentation is updated (e.g., a new version of the user manual is published) and/or at periodic intervals, the cloud assistant system 120 may analyze the documentation again to extract new questions and answers, update prior-extracted questions and answer, and/or otherwise update the questions and answers database. The cloud assistant system 120 may transmit the updated questions and answers database to the assistant engine 112 for storage at the computing device 110. Thus, the questions and answers database represents a set of specific questions and answers derived from a textual base of knowledge associated with the computing device 110.

In some implementations, the assistant engine 112 performs the first line query on the computing device 110, without outbound transmission to remote devices (e.g., to cloud assistant system 120 via networks 130) for purposes of performing the first line query. For example, the assistant engine 112 may receive the user input 102, pre-process the user input 102 (e.g., convert the user input 102 into a format suitable for querying the question and answer database), search the question and answer database, and generate an output 104 at the computing device 110. Accordingly, the assistant engine 112 may perform the first line query with less latency compared to directly sending the question to the cloud assistant system 120 to determine a response.

In some implementations, in the second line or second level query, the assistant engine 112 may determine a response to the user question by searching a knowledge base associated with the computing device 110. In some implementations, the assistant engine 112 may perform a semantic search on the knowledge base, including one or more documents associated with the computing device 110 (e.g., user manual, etc.). The assistant engine may transform chunks of text from the knowledge base into embedding vectors and compare the embedding vector of the user question to those embedding vectors of knowledge base text. In some implementations, the assistant engine 112 may search the knowledge base using retrieval-augmented generation based on an LLM, in which the assistant engine 112 retrieves text chunks relevant to the user question and uses them as context for generating an answer to the user question.

In some implementations, similar to the first line query, the assistant engine 112 may receive a user input indicating whether the user is satisfied with the output answer output by the assistant engine 112 for the second line query. If the user is satisfied with the output answer, the assistant engine 112 may end the second line query and return to standby awaiting a subsequent user question. If the user is not satisfied with the output answer, or if the assistant engine 112 fails to output an answer (e.g., the assistant engine 112 failed to identify a best matching question based on the semantic search of the knowledge base, the semantic search performed by the assistant engine 112 failed to identify a chunk of text within the knowledge base whose vector similarity to the user question is above a predetermined threshold), the assistant engine 112 may escalate the question to a third line or third level query.

In some implementations, the assistant engine 112 performs the second line query on the computing device 110, without outbound transmission to remote devices (e.g., to cloud assistant system 120 via networks 130) for purposes of performing the second line query. For example, the assistant engine 112 may perform the semantic search and output an answer using retrieval-augmented generation, based on an LLM, to identify an answer. The retrieval-augmented generation and the semantic search, including the associated LLM processing, are performed at the computing device 110. Data associated with the LLM and the knowledge base are also stored at the computing device 110 and accessed therein. Accordingly, the assistant engine 112 may perform the second line query without incurring the latency associated with sending the question to the cloud assistant system 120 to determine a response.

In some implementations, in the third line or third level query, the assistant engine 112 may determine a response to the user question by sending the question to the cloud assistant system 120. In some implementations, the assistant engine 112 may interface with the cloud assistant system 120 via an application programming interface (API). The assistant engine 112 may, using the API, send the question to the cloud assistant system 120 via the one or more networks 130. The cloud computing system 120 may attempt to identify an answer to the question using an LLM or any other suitable machine learning model or technique. For example, the cloud computing system 120 may analyze the knowledge base associated with the computing device 110 and optionally other resources using an LLM to identify an answer. If the cloud assistant system 120 identifies an answer, the cloud computing system 120 may send the answer back to the assistant engine 112, using the API, via the networks 130. The assistant engine 112 may output the answer as the output 104.

In some implementations, the cloud computing system 120, having more computing resources at disposal than the assistant engine 112 at the computing device 110, may identify an answer with a higher degree of accuracy compared to the assistant engine 112. For example, the LLM implemented by the cloud computing system 120 may be more highly trained and have more computing resources (e.g., processing power, memory, storage) available compared to the LLM implemented by the assistant engine 112. However, sending the question to, and receiving an answer back from, the cloud assistant system 120 incurs a latency associated with communication between the computing device 110 and the cloud assistant system 120 that may be absent in the first and second line queries. Accordingly, the user question may be escalated to the third line query when the first and second line queries fail to produce an answer that is acceptable to the user, and not escalated otherwise.

FIG. 2 illustrates a block diagram of an example assistant engine 112, according to some implementations. FIG. 2 illustrates the assistant engine 112 of FIG. 1 in further detail. As shown, assistant engine 112 includes a user interface module 240 and an assistant module 210.

The user interface module 240 is configured to detect user inputs to the assistant engine 112 and perform pre-processing on such user inputs (e.g., user input 102) to convert the user inputs into text (e.g., text of a user question) suitable for the assistant module 210. The user interface module 240 is also configured to output responses to user questions received from the assistant module 210. In some implementations, the user interface module 240 may include a voice activity detection module 242, a speech to text module 244, and a text to speech module 246.

In some implementations, the user input 102 may include speech spoken by a user. The speech may be captured by a microphone at the computing device 110. The voice activity detection module 242 is configured to detect speech in sounds captured by the microphone (e.g., detect speech sounds spoken by the user amidst environmental sounds).

The speech to text module 244 is configured to convert the speech detected in the user input 102 to text. The speech to text module 244 may convert the speech detected in user input 102 into question text 206 using a machine learning or artificial intelligence based technique. In some implementations, the speech to text module 244 executes locally at the computing device 110 using on-device models, without communication to remote devices or systems. An example of a speech to text model that may be executed locally without communication to remote devices is “Moonshine.” The user interface module 240 may transmit the question text 206 to the assistant module 210.

In some implementations, the user interface module 240 may detect a hotword in the user input 102 or the question text 206. The assistant engine 112 may require that speech intended for the assistant engine 112 be preceded by a predefined hotword or wakeup word (or a phrase serving a similar purpose) to signal that the question is indeed intended for the assistant engine 112. Accordingly, the user interface module 240 may detect hotwords (e.g., “Hey Assistant,” “Hey Siri,” “OK Google,” etc.) to distinguish speech (e.g., a question) intended for the assistant engine 112 versus other speech. If the user interface module 240 detects the hotword in the user input 102 or the corresponding question text 206, the user interface module 240 may transmit the question text 206 to the assistant module 210. If the user interface module 240 does not detect the hotword, the user interface module 240 may disregard the user input 102 and wait for a next user input. In some other implementations the assistant module 210 may perform hotword detection on the question text 206 instead of the user interface module 240.

In some implementations, the user interface module 240 may include capability to make a text-based user input 102 rather than speech or voice. For example, the user interface module 240 may include a graphical user interface (GUI) that may be displayed on a display device of the computing device 110. The user may input a question as text via the GUI using a touch sensitive surface (e.g., touchscreen, touchpad, etc.), one or more physical buttons, one or more physical dials, or any other suitable input device of the computing device 110. When the user input 102 is input as text, the user interface module 240 may bypass the voice activity detection module 242 and the speech to text module, and transmit the user input 102 as question text 206 to the assistant module 210.

The text to speech module 246 is configured to convert an answer 208 received from the assistant module 210 into speech. The assistant module 210 may send text of the answer 208 responsive to the question text 206 to the user interface module 240. The text to speech module 246 may convert the text of the answer 208 to speech and output the converted answer as the output 104 via an audio output device (e.g., a speaker) of the computing device 110. The user interface module 240 may output the text of the answer 208 as text in addition to or alternatively to outputting the answer 208 as speech. In some implementations, the text to speech module 246 executes locally at the computing device 110 using on-device models, without communication to remote devices or systems. An example of a speech to text model that may be executed locally without communication to remote devices is “Piper.”

The assistant module 210 includes a sentence transformer module 212, a QA search module 214, a local LLM module 216, and a cloud module 218. The sentence transformer 212 is configured to transform the question text 206 into an embedding vector 207 that represents the meaning of the question text 206. The sentence transformer module 212 sends the embedding vector 207 to the QA search module 214.

In a first line query for the user question, the QA search module 214 searches a QA database 232 stored at the computing device 110 for a question that matches the embedding vector 207 (e.g., the closest question in similarity based on cosine similarity). In some implementations, the questions in the QA database 232 are stored as embedding vectors. Accordingly, the QA search module 214 may search the QA database 232 by comparing the embedding vectors of the questions to the embedding vector 207. In implementations where the questions in the QA database 232 are stored as text, the text of the questions from the QA database may be transformed into embedding vectors for comparison to the embedding vector 207.

In some implementations, the QA database 232 is generated by the cloud assistant system 120. The cloud assistant system 120 may analyze a set of documents associated with the computing device 110 (e.g., manuals, support articles, user guides, technical specifications, etc.) stored in a knowledge base 224, using machine learning models and techniques (e.g., an LLM) at the cloud assistant system 120, to extract specific questions and corresponding answers associated with the computing device 110. For example, for a washing machine, a specific question may be “what are the default wash settings for the ‘cold wash’ mode preset?”, and the corresponding answer may be “normal dirt level, cold temperature water, medium spin, 1 hour.” The QA database 232 may include one or more specific questions (which may be stored in the database 232 as text and/or embedding vector) and respective corresponding answers (which may also be stored in the database 232 as text and/or embedding vector) associated with the computing device 110

In response to finding a matching question in the QA database 232, the QA module 214 may retrieve the answer 208 corresponding to the matching question from the QA database 232. The answer 208 may be stored in the QA database 232 as text. The QA module 214 sends the answer 208 to the user interface module 240, which may output an output 104 containing the text of the answer 208 or speech converted from the text of the answer 208 by the text to speech module 246. In some implementations, the user interface module 240 may prompt the user to indicate whether the answer 208 is satisfactory or otherwise acceptable to the user. If the user indicates that the answer 208 is acceptable, the assistant module 210 may end the first line query and be on standby for a next question.

If the user indicates that the answer 208 is not acceptable, or if the QA search module 214 is unable to find a matching question in the QA database 232, the assistant module 210 may escalate the user question to a second line query, which may be handled by the local LLM module 216.

The local LLM module 216 is configured to determine an answer to the user question based on a knowledge base 234. The local LLM module 216 may search through the knowledge base 234 for a match to the embedding vector 207. Upon finding a match, the local LLM module 216 may retrieve the corresponding answer from the knowledge base 234. In some implementations, the local LLM module 216 searches the knowledge base 234 using retrieval-augmented generation techniques, based on an LLM local to the computing device 110. The local LLM module 216 may retrieve chunks of text from the knowledge base 234, transform those chunks to embedding vectors, and compare those embedding vectors to the embedding vector 207. Based on these comparisons, the local LLM module 216 may identify an answer to the user question, and output that answer as answer 208 to the user interface module 240.

In some implementations, the knowledge base 234 includes one or more documents associated with the computing device 110. Examples of such documents include user manuals, quick start guides, troubleshooting guides, support articles, technical specifications, and other user and support documentation for the computing device 110.

In some implementations, the user interface module 240 may prompt the user to indicate whether the answer identified by the local LLM module 216 is satisfactory or otherwise acceptable to the user. If the user indicates that the answer identified by the local LLM module 216 is acceptable, the assistant module 210 may end the second line query and be on standby for a next question. If the user indicates that the answer identified by the local LLM module 216 is not acceptable, or if the local LLM module 216 is unable to identify an answer from the knowledge base 234, the assistant module 210 may escalate the user question further, to a third line query, which may be handled by the cloud module 218.

The cloud module 218 is configured to communicate with a cloud assistant system 120 via one or more networks (e.g., networks 130 of FIG. 1). In some implementations, the cloud module 218 implements an application programming interface (API). The cloud module 218 may transmit communications to and/or receive communications the cloud assistant system 120 via the API. When the assistant module 210 escalates the user question to the third line query, the cloud module 218 may send the embedding vector 207 to the cloud assistant system 120 using the API. The cloud assistant system 120 may identify an answer for the user question by analyzing a knowledge base 224 using an LLM.

In some implementations, the cloud-based knowledge base 224 includes documentation associated with the computing device 110 as well as other resources and information related to the computing device 110. For example, for a consumer appliance, the other resources and information may include, for example, webpages and forum messages discussing the appliance. In some implementations, the knowledge base 234 stored locally at the computing device 110 is a portion of the knowledge base 224.

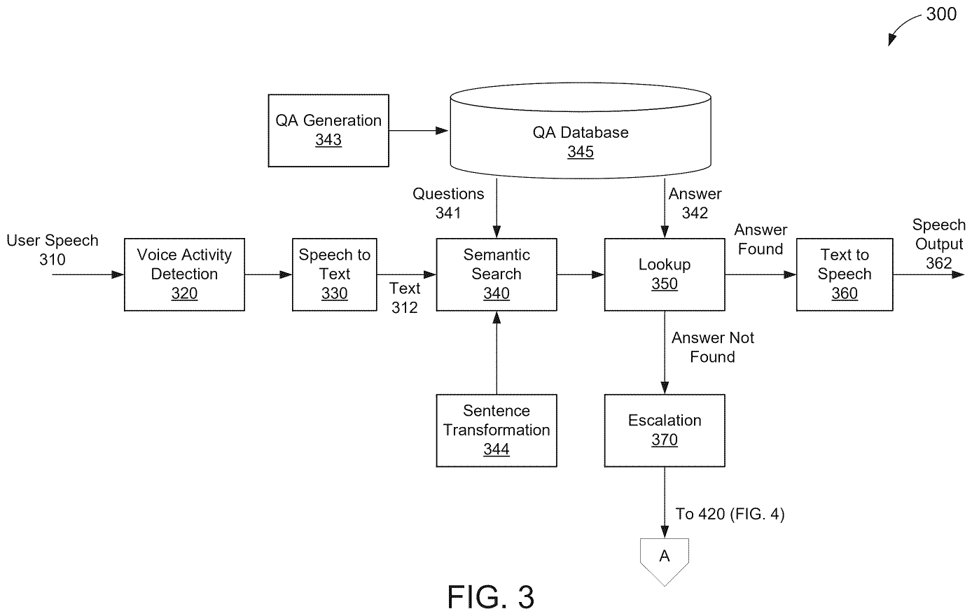

FIG. 3 illustrates an example of an operational flow 300 for a first line query for an artificial intelligence (AI) assistant, according to some implementations. For purposes of illustration, flow 300 may illustrate an operation flow for an AI assistant (e.g., as implemented by an assistant engine 112) implemented in a computing device (e.g., computing device 110), where the computing device is a household appliance, but this is not intended to be limiting. As such, the description below may reference various aspects (e.g., elements, components, etc.) shown in FIGS. 1-2. In some implementations, a custom or device-specific database of questions and answers may be generated for a device such as a household appliance, to address possible issues with the appliance. An AI assistant in a household appliance may omit capability to answer general knowledge questions, such as “what is the capital of Bolivia”, but instead may be tailored to questions specific to the appliance, such as “why are my dishes not clean” or “can I put plastic in the dishwasher” in the case of a dishwasher. Operational flow 300 illustrates a flow for an AI assistant implemented as part of a dishwasher, laundry washer or dryer, a refrigerator or another type of appliance not specifically mentioned. In particular, operational flow 300 illustrates a flow for a first line query for an AI assistant implemented at an appliance.

As shown, the flow 300 includes a user issuing user speech 310. The user speech may include a speech command (e.g., a user question) and which may be input to the AI assistant (e.g., assistant engine 112). The appliance may include microphones or other input devices to record and process speech inputs. The assistant engine 112 may perform voice activity detection 320 (e.g., via the voice activity detection module 242) to detect the user speech and may activate further processing of the user speech.

The assistant engine 112 may perform speech to text processing 330 on the user speech 310 to convert the user speech to text 312. The speech-to-text processing may, without limitation, be performed by a commercial solution or by a proprietary solution. In some implementations, the speech-to-text processing may be performed on-device at the appliance (e.g., using an on-device speech-to-text model such as the “Moonshine” model). The converted text 312 may be input into a semantic search 340. In some implementations, the text 312, which includes the user question included in user speech 310, may be an example of question text 206 of FIG. 2. In some implementations, the assistant engine 112 (e.g., the sentence transformer module 212) may perform sentence transformation 344 on the text 312 to transform the text 312 into an embedding vector (e.g., embedding vector 207). The QA search module 214 may perform a semantic search 340 using the embedding vector of the text 312.

A QA database 345 may be generated 343 offline. In some implementations, the QA database 345 is an example of the QA database 232 of FIG. 2. The QA database 345 may include a set of pre-generated questions and answers. The pre-generated questions and answers may be generated based on (e.g., extracted from) a knowledge base (e.g., knowledge base 224) of information (e.g., documentation) associated with the appliance, such as a user manual, technical specifications, support article, or other reference material. A cloud-based system (e.g., cloud assistant system 120) may generate 343 the QA database 345 using an LLM (e.g., analyze the knowledge base using the LLM) and send the QA database 345 to the appliance for storage at the appliance.

For the semantic search 340, a set of questions 341 may be obtained based on the QA database 345. The QA search module 214 may retrieve the questions 341 from the QA database 345 as input into the semantic search 340. In some implementations, the questions 341 may be in embedding vector form; the QA database 345 stores embedding vectors of questions. In some implementations, if the questions 341 are in text form, the assistant engine 112 may also perform sentence transformation 344 (e.g., using sentence transformer module 312) on the texts of the questions 341 to transform them into embedding vectors. The QA search module 214 may perform the semantic search 340 using the embedding vector of the text 312 and the embedding vectors of the questions 341. For example, the QA search module 214 may match the embedding vector of the text 312 to the embedding vectors of the questions 341. The semantic search 340 may match the user question in the text 312 to the closest or most similar question 341 stored in the QA database 345.

The QA search module 214 may perform a lookup operation 350 to retrieve an answer 342 from the QA database 345. The retrieved answer may be the answer corresponding to the question matched during the semantic search 340 and may represent the closest match based on a predetermined quality metric.

Having found an answer from the QA database 345, the assistant module 210 may send the retrieved answer 342 (e.g., as answer 208) to the text to speech module 246. The text to speech module 246 may perform a text to speech operation 360 to convert the retrieved answer 342 from text to speech, and may play the speech as speech output 362 (e.g., output 104) on an audio output device, including but not limited to a speaker or a headphone. In some implementations, the text-to-speech processing may be performed on-device at the appliance (e.g., using an on-device text-to-speech model such as the “Piper” model). The audio playback device may include a communication protocol, including but not limited to Bluetooth for playing the speech output 362 on a remote device (e.g., a device paired with the computing device 110). In some implementations, the text to speech module 246 may cache, at the computing device 110, the audio data of converted speech for one or more prior retrieved answers. If a retrieved answer 342 has cached audio data at the computing device 110, the text to speech module 246 may output that cached audio data instead of performing the text to speech operation on the retrieved answer 342.

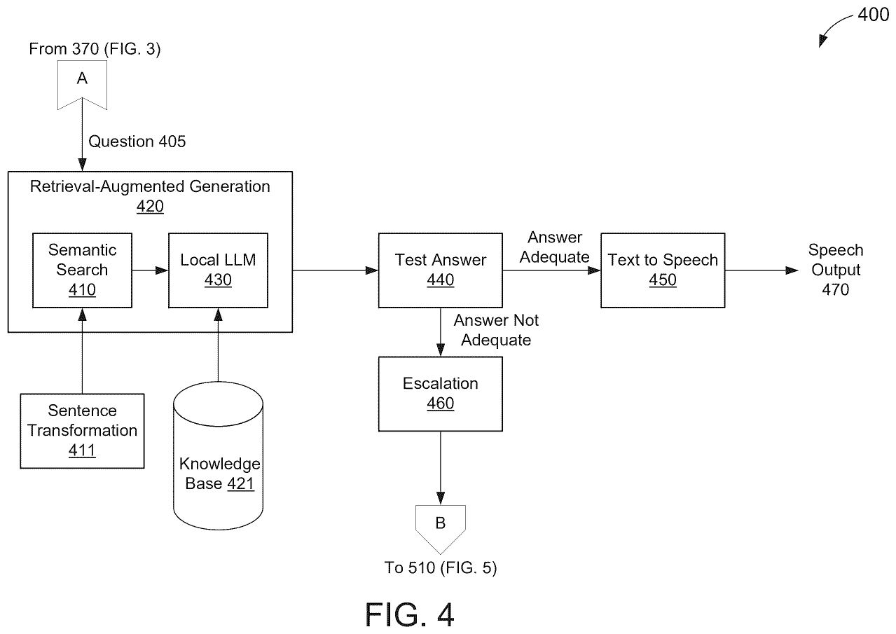

If the lookup operation 350 fails to match the user with an answer (e.g., because the semantic search 340 failed to match the user question with a question 341), or if the user was not satisfied with the output answer, the assistant engine 112 may escalate 370 the user question to a second line query, shown in FIG. 4 below.

FIG. 4 illustrates an example of an operational flow 400 for a second line query for an AI assistant, according to some implementations. Operational flow 400 follows on from the example shown in FIG. 3. In particular, operational flow 400 illustrates a flow for a second line query when the first line query in operational flow 300 is escalated. As such, the description below may reference various aspects (e.g., elements, components, etc.) shown in FIGS. 1-3.

The user question 405 (e.g., in embedded vector form as transformed from text 312) may be input to a retrieval-augmented generation operation 420. The retrieval-augmented generation 420 may include a semantic search 410 based on a local (on-device) LLM 430. The semantic search 410 may include atomic text fragments organized as vectors based on their meaning. The atomic text fragments may include chunks of text from a knowledge base 412 (e.g., knowledge base 234), which may include user manuals and other documentation associated with the appliance. The text fragments may be transformed 411 by a sentence transformer module 212 from text into embedding vectors. In some implementations, the retrieval-augmented generation 420 may be performed by the assistant module 210, including the local LLM module 216.

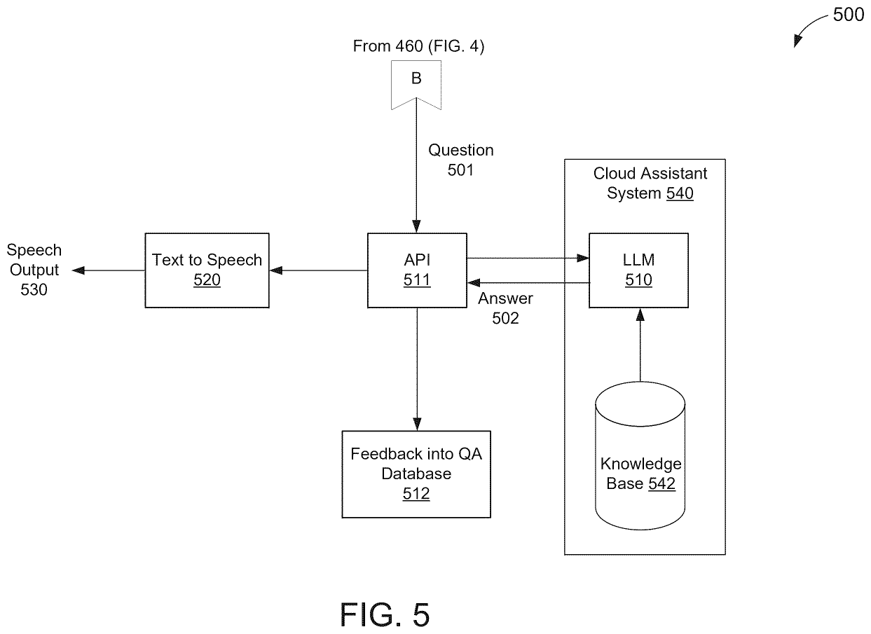

An answer may be generated based on the retrieval-augmented generation 420. The assistant module 210 may send the answer to the user interface module 240, which may test the answer 440 by prompting the user to indicate whether the answer is adequate or otherwise acceptable or satisfactory. If the user indicates that the answer is not adequate, based on feedback from a user, the user question may be escalated 460 to a third-line query, shown in FIG. 5 below. Additionally, if the answer is not adequate based on feedback from the local LLM (e.g., a confidence level or the like output by the local LLM is below a threshold), the user question may be escalated 460 to the third-line query.

If the answer is deemed adequate, the assistant module 210 may send the answer generated by the retrieval-augmented generation 420 to the text to speech module 246. The text to speech module 246 may perform a text to speech operation 450 to convert the answer from text to speech, and may play the speech as speech output 470 (e.g., output 104) on an audio output device, including but not limited to a speaker or a headphone. In some implementations, the text-to-speech processing may be performed on-device at the appliance (e.g., using an on-device text-to-speech model such as the “Piper” model). The audio playback device may include a communication protocol, including but not limited to Bluetooth for playing the speech output 470 on a remote device (e.g., a device paired with the computing device 110).

FIG. 5 illustrates an example of an operational flow 500 for a third line query for an AI assistant, according to some implementations. Operational flow 500 follows on from the example shown in FIGS. 3-4. In particular, operational flow 500 illustrates a flow for a third line query when the second line query in operational flow 400 is escalated. As such, the description below may reference various aspects (e.g., elements, components, etc.) shown in FIGS. 1-4.

The assistant module 210 (e.g., the cloud module 218) may invoke an API 511 to transmit the user question 501, in embedded vector form, to a cloud assistant system 540 (e.g., cloud assistant system 120). The cloud assistant system 540 may utilize an LLM 510 to analyze a knowledge base 542 (e.g., knowledge base 224) to generate a response (e.g., an answer 502) to the user question 501. The cloud assistant system 540 may invoke the API 522 to transmit the generated answer 502 back to the assistant module 210. The assistant module 210 may transmit the answer 502 to the text to speech module 246. Further, in some implementations, the assistant module 210 may feedback 512 the question 502 and the answer 502 into the QA database 345 (not shown in FIG. 5).

The text to speech module 246 may perform a text to speech operation 520 to convert the answer 502 from text to speech, and may play the speech as speech output 530 (e.g., output 104) on an audio output device, including but not limited to a speaker or a headphone. In some implementations, the text-to-speech processing may be performed on-device at the appliance (e.g., using an on-device text-to-speech model such as the “Piper” model). The audio playback device may include a communication protocol, including but not limited to Bluetooth for playing the speech output 530 on a remote device (e.g., a device paired with the computing device 110).

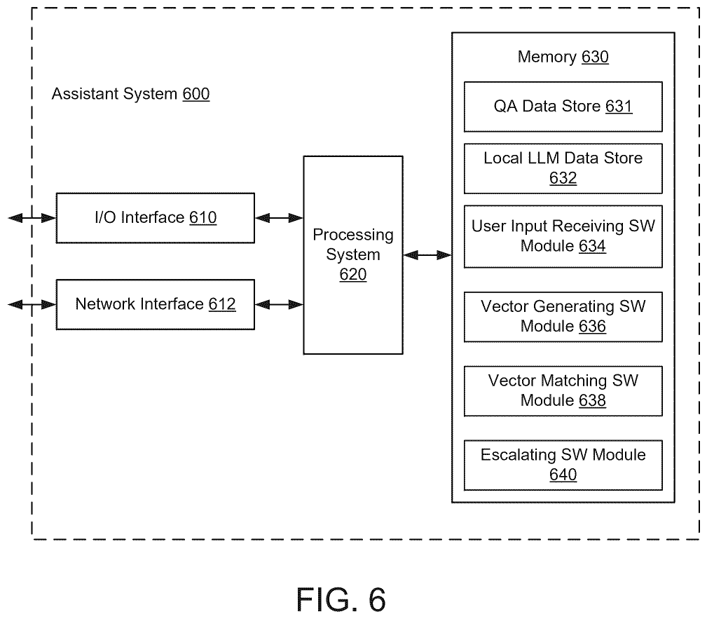

FIG. 6 shows a block diagram of an assistant system 600, according to some implementations. In some implementations, the assistant system 600 may be an example of the computing device 110 of FIG. 1.

The assistant system 600 includes I/O interface 610, network interface 612, a processing system 620, and a memory 630. The I/O interface may include one or more interfaces for communicating with one or more input, output or input/output devices. The network interface 612 may include one or more interfaces for communicating, via wired or wireless connections, with remote devices and networks, such as one or more local area networks, wide area networks, cellular networks, communicating with one or more local devices, and so on. More particularly, with respect to the present disclosure, the network interface 610 may communicatively couple the assistant system 600 to a remote assistant system, such as the cloud assistant system 120 of FIG. 1.

The memory 630 may include a QA data store 531 configured to store a database of questions and answers (e.g., QA database 232) and a local LLM data store 632 configured to store model data associated with a local large language model (e.g., for execution by a local LLM module 216). The memory 630 may include a non-transitory computer-readable medium (including one or more nonvolatile memory elements, such as EPROM, EEPROM, Flash memory, or a hard drive, among other examples) that may store at least the following software (SW) modules:
a user input receiving SW module 634 to receive a user input, where the user input includes a user question;
a vector generating SW module 636 to generate a first vector representing the user question;
a vector matching SW module 638 to match the first vector to a second vector representing a question stored in a database of questions and answers (e.g., QA data store 631); and
an escalating SW module 640 to selectively escalate the user question for processing by a machine learning model.

Each software module includes instructions that, when executed by the processing system 620, causes the assistant system 600 to perform the corresponding functions.

The processing system 620 may include any suitable one or more processors capable of executing scripts or instructions of one or more software programs stored in the assistant system 600 (such as in the memory 630). For example, the processing system 620 may execute the vector generating SW module 636 to generate a vector representing the user question. Similarly, the processing system 620 may execute the vector matching SW module 638 to match the vector representing the user question to a vector representing a question stored in the QA data store 631.

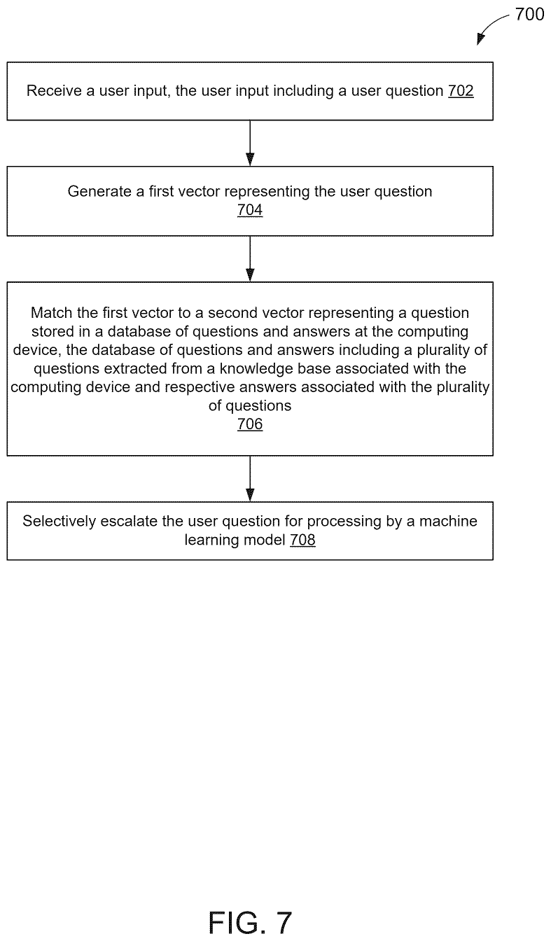

FIG. 7 illustrates a flowchart depicting an example method 700 of operating an AI assistant, according to some implementations. The method 700 may be performed by the computing device 110, e.g., as discussed in reference to FIGS. 1-2.

As illustrated, at block 702, the computing device receive a user input. The user input includes a user question. At block 704, the computing device generating a first vector representing the user question.

At block 706, the computing device matches the first vector to a second vector representing a question stored in a database of questions and answers at the computing device. The database of questions and answers includes a plurality of questions extracted from a knowledge base associated with the computing device and respective answers associated with the plurality of questions. At block 708, the computing device selectively escalates the user question for processing by a machine learning model.

In some aspects, the user input includes speech corresponding to the user question, and the computing device may convert the speech to a text corresponding to the user question.

In some aspects, the computing device may transform a text of the user question into the first vector.

In some aspects, the knowledge base associated with the computing device includes documentation associated with the computing device.

In some aspects, the plurality of questions and the respective answers associated with the plurality of questions are extracted from the knowledge base based on a large language model (LLM).

In some aspects, the plurality of questions and the respective answers associated with the plurality of questions are extracted from the knowledge base by a system remote from the computing device and transmitted from the remote system to the computing device.

In some aspects, the computing device may determine a closest vector to the first vector amongst the respective vectors representing the plurality of questions.

In some aspects, the computing device may retrieve from the database of questions and answers an answer associated with the second vector; and output the answer associated with the second vector.

In some aspects, the computing device may convert a text of the answer associated with the second vector to speech; and output the speech as audio.

In some aspects, the computing device may refrain from escalating the user question if a user response indicates that the output answer is acceptable; and escalate the user question if the user response indicates that the output answer is not acceptable.

In some aspects, the computing device may perform a semantic search of the knowledge base based on the escalated user question and a large language model (LLM).

In some aspects, the computing device may selectively send the user question to a cloud-based system for processing based on an LLM by the cloud-based system.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, implementations have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for operating an artificial intelligence (AI) assistant comprising, at a computing device:
receiving a user input, the user input including a user question;
generating a first vector representing the user question;
matching the first vector to a second vector representing a question stored in a database of questions and answers at the computing device, the database of questions and answers including a plurality of questions extracted from a knowledge base associated with the computing device and respective answers associated with the plurality of questions; and
selectively escalating the user question for processing by a machine learning model.

2. The method of claim 1, wherein the user input includes speech corresponding to the user question, and wherein the method further comprises converting, by the computing device, the speech to a text corresponding to the user question.

3. The method of claim 1, wherein the generating of the first vector comprises transforming a text of the user question into the first vector.

4. The method of claim 1, wherein the knowledge base associated with the computing device includes documentation associated with the computing device.

5. The method of claim 1, wherein the plurality of questions and the respective answers associated with the plurality of questions are extracted from the knowledge base based on a large language model (LLM).

6. The method of claim 1, wherein the plurality of questions and the respective answers associated with the plurality of questions are extracted from the knowledge base by a system remote from the computing device and transmitted from the remote system to the computing device.

7. The method of claim 1, wherein the matching of the first vector to the second vector comprises determining, by the computing device, a closest vector to the first vector amongst the respective vectors representing the plurality of questions.

8. The method of claim 1, further comprising:
retrieving from the database of questions and answers an answer associated with the second vector; and
outputting the answer associated with the second vector.

9. The method of claim 8, wherein the outputting of the answer associated with the second vector comprises:
converting a text of the answer associated with the second vector to speech; and
outputting the speech as audio.

10. The method of claim 8, wherein the selectively escalating of the user question comprises:
refraining from escalating the user question if a user response indicates that the output answer is acceptable; and
escalating the user question if the user response indicates that the output answer is not acceptable.

11. The method of claim 1, wherein the processing of the escalated user question by the machine learning model comprises performing, by the computing device, a semantic search of the knowledge base based on the escalated user question and a large language model (LLM).

12. The method of claim 11, further comprising selectively sending the user question to a cloud-based system for processing based on an LLM by the cloud-based system.

13. A computing device, comprising:
a processing system; and
a memory coupled to the one or more processors, the memory storing instructions that, when executed by the processing system, cause the computing device to:
receive a user input, the user input including a user question;
generate a first vector representing the user question;
match the first vector to a second vector representing a question stored in a database of questions and answers at the computing device, the database of questions and answers including a plurality of questions extracted from a knowledge base associated with the computing device and respective answers associated with the plurality of questions; and
selectively escalate the user question for processing by a machine learning model.

14. The computing device of claim 13, wherein the user input includes speech corresponding to the user question, and wherein the instructions, when executed by the one or more processors, cause the computing device to:
convert the speech to a text corresponding to the user question; and
transform the text corresponding the user question into the first vector.

15. The computing device of claim 13, wherein the knowledge base associated with the computing device includes documentation associated with the computing device.

16. The computing device of claim 13, wherein the plurality of questions and the respective answers associated with the plurality of questions are extracted from the knowledge base based on a large language model (LLM).

17. The computing device of claim 13, wherein the instructions, when executed by the one or more processors, cause the computing device to:
retrieve from the database of questions and answers an answer associated with the second vector; and
output the answer associated with the second vector.

18. The computing device of claim 17, wherein the instructions, when executed by the one or more processors, cause the computing device to:
refrain from escalating the user question if a user response indicates that the output answer is acceptable; and
escalate the user question if the user response indicates that the output answer is not acceptable.

19. The computing device of claim 13, wherein the instructions, when executed by the one or more processors, cause the computing device to perform a semantic search of the knowledge base based on the escalated user question and a large language model (LLM).

20. The computing device of claim 19, wherein the instructions, when executed by the one or more processors, cause the computing device to selectively send the user question to a cloud-based system for processing based on an LLM at the cloud-based system.
